(19) United States
(12) Patent Application Publication
(10) Pub. No.: US 2005/0064153 A1
(43) Pub. Date: Mar. 24, 2005

(54) Security sensitive label and method for use

(75) Inventor: Daniel E. Pardella, Petaluma, CA (US)

Correspondence Address: HAYNES BEFFEL & WOLFELD LLP, P O BOX 366, HALF MOON BAY, CA, 94019, US

(73) Assignee: Sterling Graphics, Inc., Petaluma, CA (US)

(21) Appl. No.: 10/668,782

(22) Filed: Sep. 23, 2003

(51) Int. Cl. B32B 3/00

(52) U.S. Cl. 428/195.1

(57) ABSTRACT

A security sensitive label is applied to a product to help deter theft. The label includes a label body having inner and outer surfaces with a substrate-damaging adhesive on the inner surface. The outer surface has seller identification and theft-deterring indicia. Theft of a product may be deterred by application of the security sensitive label to the product so that if the product is stolen, (1) removal of the label may damage the substrate to which the label is applied, or (2) leaving the label on the product will alert a subsequent purchaser to the origin of the product, so that in either case the product becomes less saleable.

### CROSS-REFERENCE TO OTHER APPLICATIONS

None.

### FEDERALLY SPONSORED RESEARCH OR DEVELOPMENT

None.

### BACKGROUND OF THE INVENTION

Theft of consumer products is a common problem. Theft can occur during transportation, from warehouses and from retail stores, such as grocery stores. A wide variety of security devices have been devised to help prevent theft. One well-known system, often used in retail stores, involves applying a remotely sensible device to high value items in conjunction with a remote sensor at the exits. If the remotely sensible device is not either removed from the product or the actuated, an alarm sounds when the customer passes through the sensor at an exit. One problem with this type of system is that it is relatively expensive to implement and slows down checking out because of the time taken to deactuate or remove the device. Therefore, in some situations, such as the retail grocery store environment, such a system is not generally considered practical.

Another type of security label helps provide identification, such as through the use of micro markings or numbers, in the event the product is stolen. A further type of security label is temper evident and tears apart if the potential thief tries to remove the label and, for example, replace it with a different label having a lower price.

See U.S. Pat. Nos. 2,845,728; 3,221,427; 4,239,261; 4,547,001; 4,763,928; 4,976,456; 5,346,259; 5,782,496 and US Published Application Nos. 2002/0021002 A1 and 2003/0047937 A1.

### BRIEF SUMMARY OF THE INVENTION

There are at least two basic types of thieves. The personal thief steals for his or her own use. The commercial thief typically steals in larger quantities for resale to or at other retail outlets. Certain areas of a grocery store, such as the liquor section, stocking high-value items are the most prone to theft.

One aspect of the present invention is the recognition that because much of the theft from certain retail establishments, such as grocery stores, is the result of commercial thieves, one way to reduce such theft is to make the product less salable. Another aspect of the invention is the recognition that certain thieves, in particular the personal thief, may be deterred if there is an indication that the product may be remotely monitored in the event it leaves the store without having been paid for.

A further aspect of the invention is directed to a security sensitive label, for application to a product to help deter theft. The label includes a label body having inner and outer surfaces with a substrate-damaging adhesive on the inner surface. The outer surface comprises seller identification and theft-deterring indicia. Theft of a product may be deterred by application of the security sensitive label to the product so that if the product is stolen, (1) removal of the label may damage the substrate to which the label is applied, or (2) leaving the label on the product will alert a subsequent purchaser to the origin of the product, so that in either case the product becomes less saleable.

Is still further aspect of the invention is directed to a method for helping to deter theft of a product. A security sensitive label is selected. The label of comprises a label body having inner and outer surfaces with a substrate-damaging adhesive on the inner surface. The outer surface comprises seller identification and theft-deterring indicia. A label location on a product is chosen. The label location comprises an adhesive-damageable substrate with the label location being a normally visually observable location when the product is displayed for sale at retail. The label is applied to the label location on a product. Doing so helps to deter theft of the product because if the product is stolen, (1) removal of the label may damage the substrate to which the label is applied, or (2) leaving the label on the product will alert a subsequent purchaser to the origin of the product, so that in either case the product becomes less saleable.

Applying security sensitive label is to products will typically require additional labor. However, inventory studies have shown over a 50% reduction in lost inventory when a security sensitive label made according to the invention is used. Therefore, the additional labor costs required to apply the labels is offset by the time necessary to restock the shelves. When the security sensitive labels are used to reduce theft of high-value items, substantial monetary savings can also be realized.

Various features and advantages of the invention will appear from the following description in which the preferred embodiments have been set forth in detail in conjunction with the accompanying drawings.

### BRIEF DESCRIPTION OF THE DRAWINGS

FIG. 1 is enlarged view of a security sensitive label made according to the invention;

FIG. 2 illustrates the application of the security sensitive label of FIG. 1 to the front label of a bottle of wine; and

FIG. 3 shows the security sensitive label of FIG. 1 applied to the front of a packaged product.

### DETAILED DESCRIPTION OF THE INVENTION

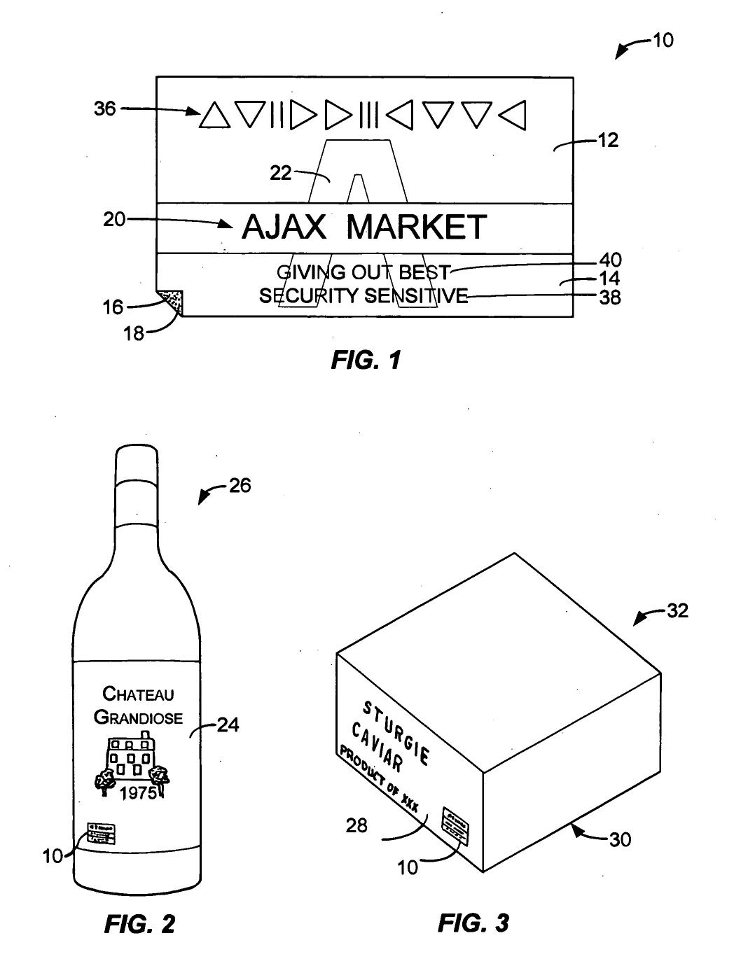

FIG. 1 illustrates a security sensitive label 10, enlarged to show detail. A typical size for the label 10 is 1.375 in. by 0.75 inch; label 10 may be larger or smaller. Security sensitive label 10 includes a label body 12 having an outer surface 14 and an inner surface 16. Inner surface 16 has a substrate-damaging adhesive 18 applied thereto. Adhesive 18 is typically a high strength, contact adhesive chosen such that when label 10 is applied to a substrate, such as a paper label, the substrate is destroyed or damaged if security sensitive label 10 is removed from the substrate. The label body 12 is typically paper with a paper-substrate-damaging adhesive. Other materials for label body 12, such as paper or a composite, may also be used. A preferred self-adhesive paper label stock is sold as TP-500 by Technicote of Miamisburg, Ohio. Other substrate-damaging adhesives may be used when the substrate is other than paper, such as a polymer film or paint.

The purpose of security sensitive label 10 is to help prevent theft of the product to which is applied. One aspect of the present invention is the recognition that because much of the theft from certain retail establishments, such as grocery stores, is the result of commercial thieves, one way to reduce such theft is to make the product less salable. Another aspect of the invention is the recognition that certain thieves, in particular the personal thief, may be deterred if there is an indication that the product may be remotely monitored in the event it leaves the store without having been paid for. To help accomplish these objectives, label 10 includes store identification, specifically the store, or other seller, name 20 and the store logo 22. Therefore, if a product has been stolen from store A, is very unlikely that store B would purchase or display such a product displaying security sensitive label 10 of store A. However, because label 10 is applied to a product substrate, such as front label 24 applied to a bottle of wine 26, shown in FIG. 2, or the front 28 of a package 30 of a packaged product 32, shown in FIG. 3, store B would likely not purchase the stolen product from the thief unless security sensitive label 10 had previously been removed. However, the use of substrate-damaging adhesive 18 will cause, for example, front label 24 or front 28 of package 30 to be damaged if security sensitive label 10 is removed. In either event, that is the presence of a security sensitive label 10 for store A or the damage to the packaging caused by removal of the security sensitive label, may make the product not sellable or sellable only at a substantially reduced price. Either option makes the product much less desirable to steal by the commercial thief.

In addition to store name 20 and store logo 22, security sensitive label 10 has theft-deterring indicia in the form of security-type nonverbal markings 36 and security-type verbal statement 38. The use of the theft-deterring indicia is used to create an awareness in the potential thief, whether the thief is a commercial thief or a personal thief, that the product may be remotely monitored in the event it leaves the store (or other establishment) without having been paid for. Security-type nonverbal markings 36 are preferably potentially, and may be, machine-readable characters.

If desired, a promotional statement, such as statement 40, may be included on label 10 for marketing purposes. In the disclosed embodiment, the words “security sensitive” constitute security-type verbal statement 38; statement 38 may include a greater or lesser number of words and may include different words, such as “monitored”, “monitored product”, “special inventory”, etc.

Other modification and variation can be made to the disclosed embodiments without departing from the subject of the invention as defined in following claims. For example, more than one security sensitive label 10 may be applied to a product.

Any and all patents, patent applications and printed publications referred to above are incorporated by reference.

1. A security sensitive label, for application to a product to help deter theft, comprising:
a label body having inner and outer surfaces;
a substrate-damaging adhesive on the inner surface; and
the outer surface comprising:
seller identification; and
theft-deterring indicia;
whereby theft of a product may be deterred by application of the security sensitive label to the product so that if the product is stolen, (1) removal of the label may damage the substrate to which the label is applied, or (2) leaving the label on the product will alert a subsequent purchaser to the origin of the product, so that in either case the product becomes less saleable.

2. The security sensitive label according to claim 1 wherein the theft-deterring indicia comprises:
a security-type nonverbal marking; and
a security-type verbal statement.

3. The security sensitive label according to claim 2 wherein the security-type nonverbal marking comprises a plurality of potentially machine-readable characters.

4. The security sensitive label according to claim 2 wherein the security-type verbal statement comprises the phrase security sensitive.

5. The security sensitive label according to claim 1 wherein the label body comprises a paper label body.

6. The security sensitive label according to claim 1 wherein the label body comprises a polymer film label body.

7. The security sensitive label according to claim 1 wherein the substrate-damaging adhesive comprises a paper-substrate-damaging adhesive.

8. The security sensitive label according to claim 1 wherein the seller identification comprises a logo.

9. The security sensitive label according to claim 1 wherein the seller identification comprises a word.

10. The security sensitive label according to claim 1 wherein the seller identification comprises a logo and a word.

11. The security sensitive label according to claim 1 wherein the seller identification comprises store identification.

12. The security sensitive label according to claim 1 further comprising a promotional slogan.

13. A security sensitive label, for application to a product to help deter theft from a store, comprising:
a label body having inner and outer surfaces;
a paper-substrate-damaging adhesive on the inner surface; and
the outer surface comprising:
store identification comprising a word and a logo; and
theft-deterring indicia, the theft-deterring indicia comprising:
security-type nonverbal markings; and
a security-type verbal statement;
whereby theft of a product from a store may be deterred by application of the security sensitive label to the product so that if the product is stolen from the store, (1) removal of the label will damage the paper substrate to which the label is applied, or (2) leaving the label on the product will alert a subsequent purchaser to the origin of the product, so that in either case the product becomes less saleable.

14. A method for helping to deter theft of a product comprising:
selecting a security sensitive label comprising:
a label body having inner and outer surfaces;
a substrate-damaging adhesive on the inner surface; and
the outer surface comprising:
seller identification; and
theft-deterring indicia;
choosing a label location on a product, the label location comprising an adhesive-damageable substrate, the label location being a normally visually observable location when the product is displayed for sale at retail; and
applying the label to the label location on a product;
whereby theft of the product may be deterred because if the product is stolen, (1) removal of the label may damage the substrate to which the label is applied, or (2) leaving the label on the product will alert a subsequent purchaser to the origin of the product, so that in either case the product becomes less saleable.

15. The method according to claim 14 wherein the choosing step is carried out with the adhesive-damageable substrate being a front label on a bottle.

16. The method according to claim 14 wherein the choosing step is carried out with the adhesive-damageable substrate being the front of packaging for the product.

17. A method for helping to deter theft of a product from a store at retail comprising:
selecting a security sensitive label comprising:
a label body having inner and outer surfaces;
a paper-substrate-damaging adhesive on the inner surface; and
the outer surface comprising:
store identification comprising a word and a logo; and
theft-deterring indicia, the theft-deterring indicia comprising:
security-type nonverbal markings; and
a security-type verbal statement;
choosing a label location on a product, the label location comprising a paper substrate, the label location being a normally visually observable location when the product is displayed for sale at retail; and
applying the label to the label location on a product;
whereby theft of a product from a store may be deterred by application of the security sensitive label to the product so that if the product is stolen from the store, (1) removal of the label will damage the paper substrate to which the label is applied, or (2) leaving the label on the product will alert a subsequent purchaser to the origin of the product, so that in either case the product becomes less saleable.
